(19) United States
(12) Patent Application Publication
(10) Pub. No.: US 2020/0311579 A1
(43) Pub. Date: Oct. 1, 2020

(54) SYSTEM AND METHOD FOR AUTOMATED TAGGING FOR SCHEDULING EVENTS

(71) Applicant: ROCALYTICS, INC, Randolph, NJ (US)

(72) Inventor: Dave DIAL, Randolph, NJ (US)

(73) Assignee: ROCALYTICS, INC, Randolph, NJ (US)

(21) Appl. No.: 16/830,771

(22) Filed: Mar. 26, 2020

Related U.S. Application Data
(60) Provisional application No. 62/823,857, filed on Mar. 26, 2019.

(51) Int. Cl. G06N 5/04; G06Q 10/10; G06N 20/00

(52) U.S. Cl. CPC G06N 5/04; G06N 20/00; G06Q 10/1095

(57) ABSTRACT

A system and method for automated tagging for scheduling applications. The method includes receiving a first scheduling event, receiving existing tags related to the first scheduling event, determining a correlation between the first scheduling event and at least a second scheduling event; and generating new tags for the first scheduling event based on the received tags and the determined correlation between the first scheduling event and the at least a second scheduling event.

### CROSS-REFERENCE TO RELATED APPLICATIONS

This application claims the benefit of U.S. Provisional Application No. 62/823,857 filed on Mar. 26, 2019, the contents of which are hereby incorporated by reference.

### TECHNICAL FIELD

The present disclosure relates generally to scheduling analytics, and more specifically to generating feedback analytics based on automated tagging for scheduling applications.

### BACKGROUND

Time is arguably the most valuable commodity in a modern corporate environment, where a business's success may be directly correlated to the amount of time spent on particular tasks, projects, or clients. An effective business requires proper management of limited resources, including not only management of economic resources, but employee effort and focus as well. One proxy of measuring efficient use of resources is determining both the time allotted to various tasks as well as related outcomes of those tasks.

Communication and scheduling software is often used to organize various internal and external activities of a business, including email clients and calendar programs. Some programs, including the ubiquitous Microsoft® Outlook® email client, includes built-in scheduling and calendar functions. While such programs may provide certain analytic tools, they are often limited in useful feedback information that can be provided. Though such programs contain a plethora of information within the mail, calendar, and contact functions, this information is rarely harnessed to effectively provide feedback for how efficient and effective a workforce is, or suggestions for improvement to time allocation.

In order to provide concrete and useful business intelligence, proper analytics of the time that has been allotted to various tasks is essential. Current solutions lack the tools to accurately determine time spent both on a granular level, as well as in a larger picture perspective. To provide suggestions for optimal business strategies based on data-based analytics, additional information must be extracted from available data to best allow business leaders to determine how to optimally allocate limited resources.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for automated tagging for scheduling events, including: receiving a first scheduling event; receiving existing tags related to the first scheduling event; determining a correlation between the first scheduling event and at least a second scheduling event; and generating new tags for the first scheduling event based on the received tags and the determined correlation between the first scheduling event and the at least a second scheduling event.

Certain embodiments disclosed herein also include non-transitory computer readable medium having stored thereon instructions for causing a processing circuitry to perform a process, the process including: receiving a first scheduling event; receiving existing tags related to the first scheduling event; determining a correlation between the first scheduling event and at least a second scheduling event; and generating new tags for the first scheduling event based on the received tags and the determined correlation between the first scheduling event and the at least a second scheduling event.

Certain embodiments disclosed herein also include a system for automated tagging for scheduling events, including: a processing circuitry; and a memory, the memory containing instructions that, when executed by the processing circuitry, configure the system to: receive a first scheduling event; receive existing tags related to the first scheduling event; determine a correlation between the first scheduling event and at least a second scheduling event; and generate new tags for the first scheduling event based on the received tags and the determined correlation between the first scheduling event and the at least a second scheduling event.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a flowchart illustrating a method for automated tagging for scheduling applications according to an embodiment.

FIG. 2 is an example schematic diagram of a server for generating automated tagging according to an embodiment.

FIG. 3 is a screenshot of a tag creation page according to an embodiment.

FIG. 4 is a screenshot of a tag suggestion page according to an embodiment.

FIG. 5 is a diagram of an analytics page according to an embodiment.

FIG. 6 is a diagram of a retroactive tagging page according to an embodiment.

FIG. 7 is an example pie chart indicating usage of time of an individual according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for automated tagging and generation of analytics based on scheduling events.

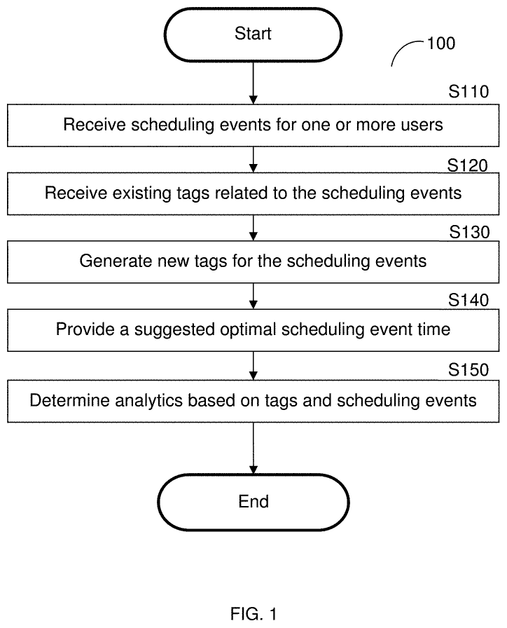

FIG. 1 shows a flowchart 100 illustrating a method for automated tagging for scheduling applications according to an embodiment.

At S110, scheduling events for one or more users is obtained, e.g., received from a calendar server. Scheduling events include calendar events, e.g., events stored within a user calendar, such as a user's Outlook® calendar. Calendar events may include internal meetings with coworkers, external meetings with clients, time set aside for individual work, and the like. Each event may include multiple parameters, such as the name of a meeting, the names of parties participating in the meeting, times and dates of the meeting, and the like. In an embodiment, scheduling events received include data related to the scheduling events and is third-party data, such as time-based metadata related to a scheduling event where the data is stored, created, or modified by a third-party, e.g., an off-site Microsoft® Exchange® server.

At S120, existing tags related to each of the calendar events are obtained, e.g., received from a server. The server may be the calendar server from where scheduling events are received, or a separate server. Existing tags include descriptions of the various parameters of the calendar events. Examples of such tags include a company name, and employee name or ID, a case number related to the calendar event, email addresses of relevant parties, location of a meeting, time and date of an event, and the like. In an embodiment, each calendar event is assigned a department tag describing internal departments within a company. For example, a department tag may indicate that a particular calendar event, such as a meeting, may be associated both with a research and development (R&D) team and with a sales team. Thus, a single calendar event may include a plurality of tags.

In an embodiment, at least one of the tags is provided by a user. For example, when a user creates a meeting, they may be required to input the email addresses of parties invited to the meeting. Additional tags may be suggested based on the provided tags. Thus, if a user is part of an R&D team, and creates a meeting that includes the email addresses of other members of the R&D team as well as members of a programming team, the tags ‘R&D’ and ‘Programming’ may be suggested to a user. In an embodiment, the suggested tags are displayed on a user device that is configured to allow a user to select any desired tags to associate with the event. In an example embodiment, the user is present with suggested tags on a computer display where they can be easily selected. Further, additional custom tags that have not been suggested may be created by a user an added to the scheduling event.

At S130, relevant new tags are generated and assigned to each of the scheduling events. The tags are generated based on the existing tags and a determined correlation between a first scheduling event and a second scheduling event, e.g., a current scheduling event and one or more prior scheduling events. The new tags are applied from a prior event to a correlated current event. For example, if all prior meetings located at location X are conducted with client Y, a current scheduling event created by a user who provides location X as the location assigned to the event, a tag for client Y may be generated and automatically assigned to the event. Additionally, if prior meetings assigned to client Y involve both the R&D group along with the sales group, the relevant tags ‘R&D’ and ‘Sales’ may be assigned to the current event as well. Further, any tag may be determined to be correlated to any other tag based on predetermined analytics parameters, e.g., a user may be determined to be correlated to a location tag, a department tag may be determined to be correlated to a user tag, a department tag may be correlated to a project tag, and the like. This correlation among tags allows for a more robust connection among tags.

In an embodiment, the tag generation is based on matching a current event to prior events, e.g., based on the parameters of the current event, including tags, details, and metadata, and extrapolating from the tags of the prior event. For example, if all meetings scheduled within a company office with all members of the R&D department that take place for 45 minutes on a Monday morning have previously been assigned a tag of ‘R&D weekly review,’ any subsequent meeting with those parameters can be automatically assigned the tag of ‘R&D weekly review.’ Data relating to the prior meetings may be accessed from a storage, e.g., a scheduling database.

In an embodiment, artificial intelligence or machine learning is employed to generate the new tags. The generation may be achieved using, for example, machine learning techniques that includes implementation of one or more neural networks, recurrent neural networks, decision tree learning, Bayesian networks, clustering, and the like. Thus, prior meeting information can be accessed and scanned to be fed to neural network, which is configured to determine appropriate tags for any future event having shared parameters. In an embodiment, the number of shared parameters, or the matching value of the parameters, must exceed a predetermined threshold in order for a tag to be assigned thereto.

In an embodiment, the tag generation includes receiving third party data, e.g., from a remote third party database, and analyzing the data to generate new tags. The analysis may be based on a correlation, on predetermined time parameters, on similarity among prior data, and the like. The received data can be first filtered and assigned tags based on a correlation to specific data and a comparison to previously tagged data. For example, if the received data includes tickets, the times from the tickets can be analyzed and compared, and tickets can then be tagged as “trouble tickets” if a parameter exceeds a predetermined threshold, or as “normal tickets” if it does not. A graphical representation, such as a pie chart, may be generated to display the data relating to the trouble tickets and normal tickets. In an embodiment, this tagging is performed for any data pulled from a third party source having time as a basis.

At optional S140, an optimal time for the scheduling event is determined and suggested to a user. For example, based on the parties invited to a meeting, and their calendar schedules, an optimal time that is most likely to be attended by a maximum number of parties may be suggested as the time for the meeting, e.g., displayed on a user device. In an embodiment, a ranking of a number of possible times may be suggested for a user to choose therefrom. In an embodiment, the optimal time includes at least one time slot having a higher acceptance probability among multiple requested participants. An example method for facilitating meetings between multiple participants that may be suitable for use according to at least some of the disclosed embodiments is described further in U.S. patent application Ser. No. 14/735,642, now pending and assigned to the common assignee, which is hereby incorporated by reference.

At S150 analytics of a plurality of scheduling events is performed based on the existing tags and the generated tags. Analytics may include determining a breakdown of time allotted to various tasks related to the plurality of scheduling events based on associated tags. For example, a tag of ‘Client Y’ may be used to generate a list of times spent in scheduling events associated with client Y.

The level of detail and granularity of the analytics may be predetermined or adjusted by a user based on user input for a desired need. For example, upper level management of a company may be interested in the amount of total resources spent on client Y. A tally of each department that spent time on events associated with that client is retrieved, and the amount of time spent, in total, on average per week or per month, and the like, can be extrapolated and organized for presentation. Alternatively, a mid-level manager may only be interested in the time spent on client by employees under his direct management. In an embodiment, a graphical representation of the analytics is generated and displayed, e.g., a graph or slide to be shown on a user device.

In an embodiment, various tags can be added or removed as desired to dynamically update the analytics. For example, a manager may first request average time spent company-wide on a client, and then request how that time is allocated based on each department involved, as well as each individual who had been a participant in at least one of the scheduling events associated with that client.

Additionally, a user may filter the resulting analytics when reviewing the results. Thus, all meetings with or relating to a client can be first displayed, and then filtered to exclude any meeting conducted on the telephone, or any meeting that included a member of the sales department.

Such customizability allows for a user to easily review time spent on any particular task, and identify resource sinks or insufficient resources assigned to a matter. For example, a user may wish to implement a growth strategy that involves spending increased time with newer client compared to existing clients. The analytics provided can present relevant time information to properly allocate employees and other resources to newer clients.

The adjustable granularity of the analytics may be tailored to various users. For example, a lower group manager may give only permission to view analytics associated with her department and associated clients, while an upper management executive may be given full access to all company clients and associated data.

In a further embodiment, the analytics may include retroactively reviewing previous analytics to predict optimal future activity. Thus, if time spent with a client above a threshold is determined to give only diminishing returns in regard to sales and revenue, it may be determined that after a set number of meetings has already been scheduled, any additional time spent on the client must be first approved by a senior manager. In an embodiment, machine learning, as discussed above, may be implement in this determination as well.

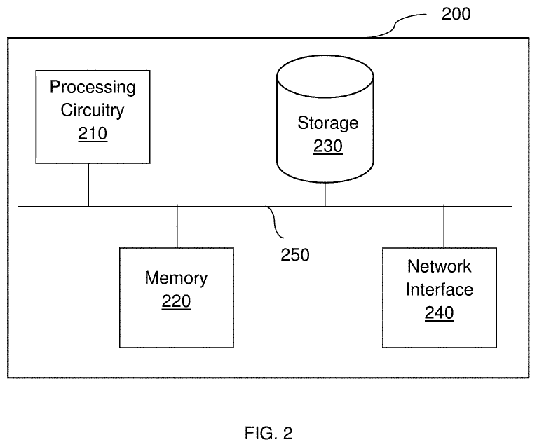

FIG. 2 is an example schematic diagram of a tagging server 200 for generating automated tagging according to an embodiment. The tagging server 200 includes a processing circuitry 210 coupled to a memory 220, a storage 230, and a network interface 240. In an embodiment, the components of the server 200 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), GPUs, tensor processing units (TPUs), general-purpose microprocessors, microcontrollers, digital signal processors (DSPs), and the like, or any other hardware logic components that can perform calculations or other manipulations of information.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause the processing circuitry 210 to perform the various processes described herein. Specifically, the instructions, when executed, cause the processing circuitry 210 to generate new tags for scheduling events, as well as generate analytics based on those tags, as described in FIG. 1.

The storage 230 may be magnetic storage, optical storage, and the like, and may be realized, for example, as flash memory or other memory technology, CD-ROM, Digital Versatile Disks (DVDs), SSD, or any other medium which can be used to store the desired information.

The network interface 240 allows the server 200 to communicate with various devices, such as user devices or various databases, or various networks connected to such devices.

It should be understood that the embodiments described herein are not limited to the specific architecture illustrated in FIG. 2, and other architectures may be equally used without departing from the scope of the disclosed embodiments.

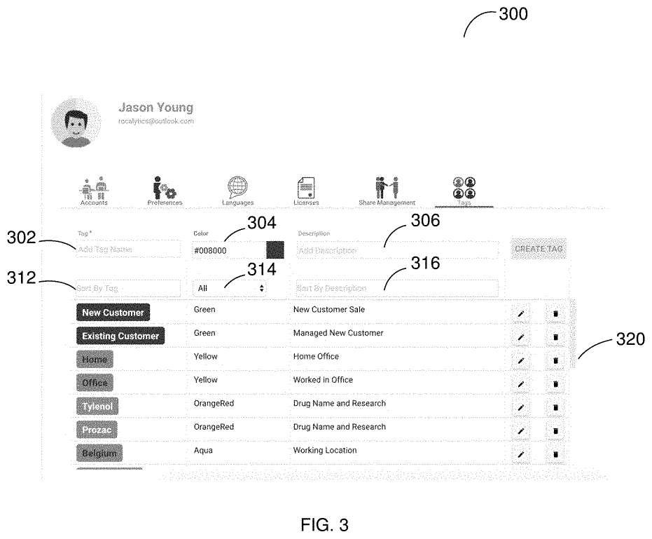

FIG. 3 is a screenshot of a tag creation page 300 according to an embodiment. The tag creation page 300 allows a user to enter new information regarding a tag, and customize various parameters thereof. An “Add Tag Name” field 302 is presented to a user to create the name of a new tag. The user may additionally select an associated color from a color picker 304, and add a description from a description field 306, allowing the tag to be easily located, both textually, e.g., via a text search, or visually, e.g., by selecting a tag with a known color.

In addition to the creation dialogs, an embodiment of the tag creation page 300 includes a search function, where preexisting tags can be found. The search function may be operated using similar name 312, color 314, and description 316 fields discussed above. A search result dialog 320 is shown to display results as filtered by the search fields. Additionally, the tags displayed may be either edited or deleted as desired. The tag creation page can be accessed at any time, without requiring a user to schedule a meeting to access the tags. This allows a user to easily edit tag settings and parameters, e.g., if a new client is added, a color shared with a client in the same industry can be applied to their tag as well to facilitate identification of similar clients.

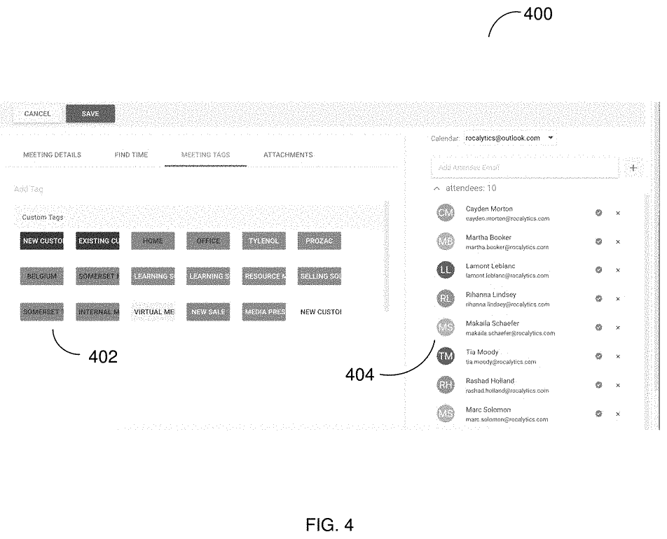

FIG. 4 is a screenshot of a tag suggestion page 400 according to an embodiment. In an embodiment, the tag suggestion page 400 is configured to be displayed when a user begins creating a meeting within the scheduling system. After a meeting schedule is initiated, a dialog is shown suggesting various tags 402, including previously created tags, and shortcuts to create new tags. The shown example of tags 402 includes location tags, e.g., home or office, Belgium of Somerset, and the like, as well as client names and internal or external departments. In an embodiment, the tags 402 further include meeting types, such as in-office meeting, out of office meeting, virtual meeting, work activity, and personal. Thus, a user is presented with the opportunity to easily select various tags by clicking on relevant parameters. In one embodiment, once a first tag is chosen, e.g., a client name, the tags that are displayed may be updated accordingly. For example, if Client A is selected first by a user in the creation of a new meeting, only locations and departments associated with that client are shown.

Moreover, the tagging of the disclosed embodiment may include an auto-tagging feature, whereby a meeting is tagged according to certain rules. For example, a predetermined rule may be created by a user to state that any meeting having the phrase “Johnson & Johnson” in the title will have the tag ‘pharmaceutical’ is added as well. Thus, a user may only be required to input a meeting title, and all relevant tags will be automatically associate with the meeting after it is created. In addition, certain attendees may be associated with the rule as well, e.g., a manager may be added as an invitee to every meeting with a specific client. A user can always be offered the option of manually adding tags as well.

In a further embodiment, the auto-tagging feature is implemented with machine learning techniques, such as artificial neural networks, deep learning, decision tree learning, Bayesian networks, clustering, and the like. Thus, for example, the user input related to various parameters of meetings, such as titles, time, location, attendees and tags, may be fed into a neural network configured to determine substantial connections and predict future relevant tags and attendees for similar meetings. The machine learning technique employed may be used to evaluate individual user choices, as well as company-wide patterns, to more accurately predict proper tagging. Thus, if all two hour meetings with a user 1 and a CEO at headquarters are tagged “Meeting with CEO,” it could be determined that a new two hour meeting between user 2 and the CEO at headquarters may also be assigned the same tag.

In addition to relevant tags, the tag suggestion page 400 may include a list of prospective meeting attendees 404. The list can include names and email addresses, or other methods of communication, e.g. chat names or social media accounts. In an embodiment, the list is updated in real-time as relevant tags are selected by the user. For example, if Client A is selected at Location A, an updated list of potential attendees may be shown to only include employees of the client who work at that location, or employees of the user's company who work with that client. Both the suggested tags 402 and the potential attendees 404 lists allow a user to easily create a tagged meeting an send an invitation to relevant people in a quick and efficient manner.

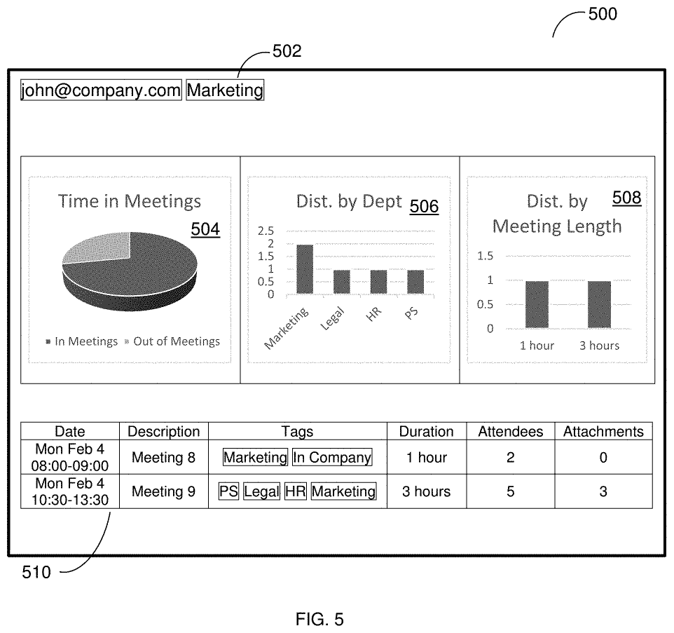

FIG. 5 is a diagram of an analytics page 500 according to an embodiment. A distinct benefit from employing the tagging and potential attendee selection discussed above is the data created for each meeting. The tags and attendees, as well as the time and location, of previously conducted meetings can be stored, e.g., within a database, and analyzed to produce useful insight relating to business intelligence. The analysis may occur automatically, e.g., at a predefined time or on a real time basis, or when a user manually requests an analysis.

As a non-limiting example embodiment, the shown screenshot of an analytics page 500 is a page of analytics relating to a specific tag or set of tags, in this case a tag including an email address and a tag for “Marketing.” This allows for analysis of resources spent by one particular user related on an activity. The analytics shown include pie charts 502 visually displaying time spend in meetings versus time spend out of meetings, bar graphs 506 indicating departments involved in these meetings, and graphics 508 showing various other meeting parameters, such as length of meetings. In addition, a summary 510 of each meeting, including tags, participants, and descriptions, can be displayed, e.g., on a user device, for more in depth detail.

In an embodiment, the levels of analysis available can be adjusted for each user. For example, a regional manager may be given access to all departments within their office, as well as the clients they are approved to deal directly with. A high level executive, on the other hand, may be given broader access to compare analytics of multiple offices, or to generate more inclusive data to represent information company-wide. This allows control over potentially sensitive data, while allowing granular control over user access.

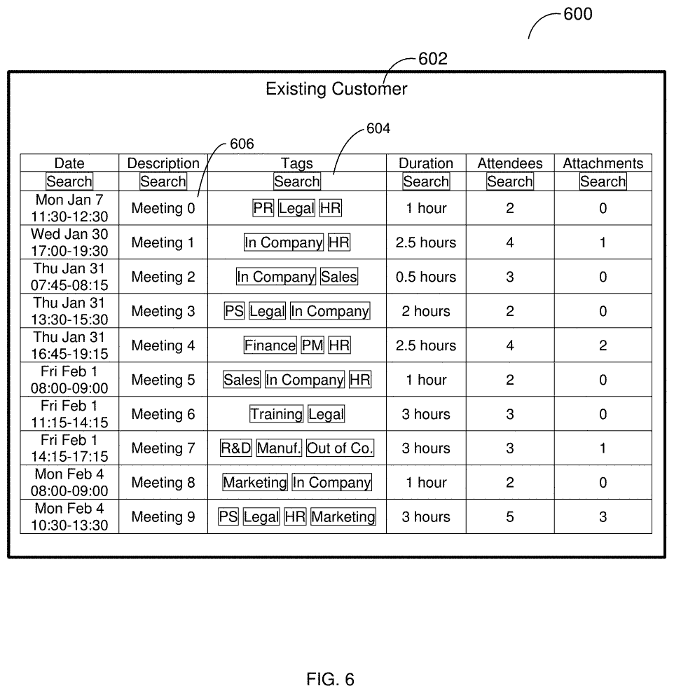

FIG. 6 is a diagram of a retroactive tagging page 600 according to an embodiment. A user can retrieve previously recorded meetings, e.g., with a specific client 602, and the listing of such meetings 606 is displayed. Search fields 604 may be used to find a particular meeting. Once the meetings are accessed, a user may retroactively assign various tags to either individual meetings, or to a batch thereof. For example, a user can select five out of ten previous meetings, and add a new tag relating to a change in relevant departments when applicable. In some embodiments, the aforementioned machine learning techniques may be implemented to analyze and tag past meetings based on current or upcoming meetings with additional information or parameters. Updating past meetings allows for the analytics discussed above in FIG. 5 to incorporate new information, creating more useful and accurate data for evaluation.

An example implementation of the disclosed embodiment may include improving the business intelligence of a law firm. Using user input and machine learning based input of tags, descriptions, attendees, and time, a managing partner of a law firm can easily view the time spent with various clients, e.g., in meetings, over the phone, and conducting work. The analytics may be further granular, allowing the partner to view which attorneys spent how much time on which clients. This allows for informed decisions, such as determining if additional resources are needed for one client or if resources are being wasted on another client with diminishing returns. Certain attorneys can be rewarded for maximizing output, while others can be told to spend less time on certain tasks of clients. These analytics allow for data-based decisions to maximize resource expenditure.

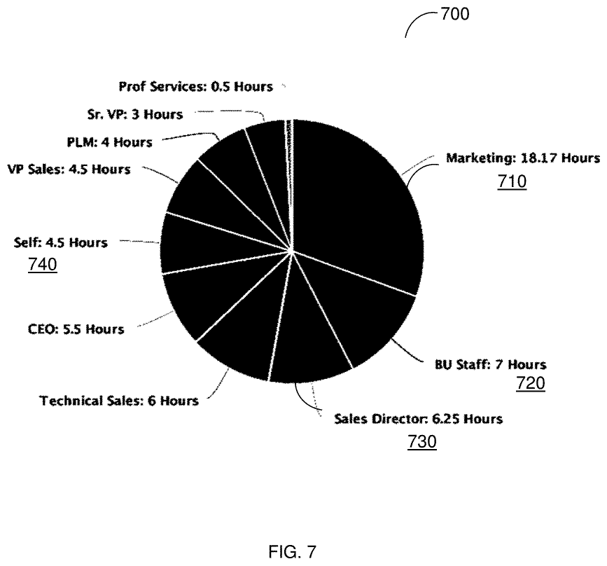

FIG. 7 is an example pie chart 700 indicating usage of time of an individual according to an embodiment. In the shown example pie chart 700, it is clearly shown that a particular individual has spent the majority of their time device devoted to marketing 710 and less than half of that with the business unit staff 720 and with a sales direction 730. In an embodiment, the pie chart 700 includes a time category assigned to “self” 740, which may indicate time spent without others present. This graphical chart may be displayed on a user device, stored within a storage for future access, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automated tagging for scheduling events, comprising:
receiving a first scheduling event;
receiving existing tags related to the first scheduling event;
determining a correlation between the first scheduling event and at least a second scheduling event; and
generating new tags for the first scheduling event based on the received tags and the determined correlation between the first scheduling event and the at least a second scheduling event.

2. The method of claim 1, further comprising:
determining an optimal time for the first scheduling event; and
displaying the determined optimal time on a user device.

3. The method of claim 1, wherein the new tags are generated using machine learning techniques.

4. The method of claim 3, wherein the machine learning techniques include at least one of: a neural network, a recurrent neural network, decision tree learning, a Bayesian network, and clustering.

5. The method of claim 1, further comprising:
determining analytics of a plurality of scheduling events, wherein the analytics include determining a breakdown of time allotted to tasks related to each of the plurality of scheduling events.

6. The method of claim 5, wherein a level of detail of the determined analytics is adjustable based on user input.

7. The method of claim 5, wherein the analytics further include predictions of future optimal activity based on past scheduling events.

8. The method of claim 5, further comprising:
generating graphical representations of the analytics; and
displaying the graphical representations on a user device.

9. The method of claim 1, where at least one existing tag is manually entered by a user.

10. A non-transitory computer readable medium having stored thereon instructions for causing a processing circuitry to perform a process, the process comprising:
receiving a first scheduling event;
receiving existing tags related to the first scheduling event;
determining a correlation between the first scheduling event and at least a second scheduling event; and
generating new tags for the first scheduling event based on the received tags and the determined correlation between the first scheduling event and the at least a second scheduling event.

11. A system for automated tagging for scheduling events, comprising:
a processing circuitry; and
a memory, the memory containing instructions that, when executed by the processing circuitry, configure the system to:
receive a first scheduling event;
receive existing tags related to the first scheduling event;
determine a correlation between the first scheduling event and at least a second scheduling event; and
generate new tags for the first scheduling event based on the received tags and the determined correlation between the first scheduling event and the at least a second scheduling event.

12. The system of claim 11, wherein the system is further configured to:
determine an optimal time for the first scheduling event; and
display the determined optimal time on a user device.

13. The system of claim 11, wherein the new tags are generated using machine learning techniques.

14. The system of claim 13, wherein the machine learning techniques include at least one of: a neural network, a recurrent neural network, decision tree learning, a Bayesian network, and clustering.

15. The system of claim 11, wherein the system is further configured to:
determine analytics of a plurality of scheduling events, wherein the analytics include determining a breakdown of time allotted to tasks related to each of the plurality of scheduling events.

16. The system of claim 15, wherein a level of detail of the determined analytics is adjustable based on user input.

17. The system of claim 15, wherein the analytics further include predictions of future optimal activity based on past scheduling events.

18. The system of claim 15, wherein the system is further configured to:
generate graphical representations of the analytics; and
display the graphical representations on a user device.

19. The system of claim 11, where at least one existing tag is manually entered by a user.
